(19) United States
(12) Patent Application Publication
(10) Pub. No.: US 2010/0161143 A1
(43) Pub. Date: Jun. 24, 2010

(54) DISPENSING SYSTEM

(76) Inventors: Christopher Lawrence Smith, Liberty Township, OH (US); Brian Joseph Roselle, Fairfield, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/636,998

(22) Filed: Dec. 14, 2009

Related U.S. Application Data
(60) Provisional application No. 61/138,539, filed on Dec. 18, 2008.

(51) Int. Cl. G05B 19/00; G05D 7/06

(52) U.S. Cl. 700/283; 340/5.8

(57) ABSTRACT

A modular fluid dispensing system is configured to dispense at least one fluid to a machine having an aperture therein. The modular fluid dispensing system comprises a module configured to be removably engaged with the aperture. The module comprises at least one receiving chamber configured to receive at least one container. The at least one container is configured to receive the at least one fluid. The module comprises at least one engagement key configured to be engaged with a receiver portion of the aperture and a fluid extracting element defines a passage therethrough. The fluid extracting element is configured to engage a portion of the at least one container to withdraw a portion of the at least one fluid from the at least one container into the passage.

### CROSS REFERENCE TO RELATED APPLICATION

This application claims the benefit of U.S. Provisional Application Ser. No. 61/138,539, filed Dec. 18, 2008.

### BACKGROUND OF THE INVENTION

Various machines, such as appliances, for example, can require a user to add a product, such a fluid, a vapor, and/or a gas to the machine at the beginning of each cycle of the machine. This can require the user to manually add the product into a portion of the machine. Some machines can require multiple products to be added to achieve various benefits. This can require the user to dispense the multiple products to the machine to achieve the various benefits and can also require a high level of user attention to ensure that the multiple products are placed in the correct portions of the machine to reduce the possibility of using the wrong products in the wrong portions of the machine. Furthermore, some machines can require the various products to be manually added to the machine during a cycle of the machine and/or at specific points throughout the cycle of the machine.

### SUMMARY OF THE INVENTION

In one embodiment, a modular fluid dispensing system is configured to dispense at least one fluid to a machine having an aperture therein. The modular fluid dispensing system comprises a module configured to be removably engaged with the aperture. The module comprises at least one receiving chamber configured to receive at least one container. The at least one container is configured to receive the at least one fluid. The module comprises at least one engagement key configured to be engaged with a receiver portion of the aperture and a fluid extracting element defining a passage therethrough. The fluid extracting element is configured to engage a portion of the at least one container to withdraw a portion of the at least one fluid from the at least one container into the passage.

In another embodiment, a modular fluid dispensing system for a machine comprises a removable module comprising a receiving chamber for receiving at least one container configured to contain at least one fluid. The removable module comprises a container authentication system configured to interact with an authentication portion of the at least one container and a fluid dosing system interface configured to interact with a selectable fluid dosing system located on the at least one container.

In yet another embodiment, an appliance comprises a modular fluid dispensing system configured to dispense at least one fluid from at least one container to the appliance. The modular fluid dispensing system comprises a module comprising a receiving chamber configured to receive the at least one container and a fluid extracting element configured to withdraw the at least one fluid from the at least one container. The module also comprises a container authentication system configured to interact with an authentication portion of the at least one container and a fluid dosing system interface configured to interact with a selectable fluid dosing system of the at least one container.

### BRIEF DESCRIPTION OF THE DRAWINGS

The above-mentioned and other features and advantages of the dispensing system, and the manner of attaining them, will become more apparent and the dispensing system itself will be better understood by reference to the following description of embodiments of the dispensing system taken in conjunction with the accompanying drawings, wherein:

FIG. 1 is a perspective view of a modular fluid dispensing system for use with a machine comprising an aperture, the modular fluid dispensing system comprising a module configured to be positioned within and removed from the aperture and at least one container configured to be positioned within the module according to one non-limiting embodiment;

FIG. 2 is a front view of the machine of FIG. 1 with the module positioned within the aperture;

FIG. 3 is a partial front view of the machine of FIG. 2 with a module door in an open position and the at least one container positioned within the module according to one non-limiting embodiment;

FIG. 4 is a partial front view of the machine of FIG. 2 with the module door in an open position without the at least one container positioned within the module according to one non-limiting embodiment;

FIG. 5 is a perspective view of the module of the modular fluid dispensing system of FIG. 1 with a module door in an open position according to one non-limiting embodiment;

FIG. 6 is a top view of the module of the modular fluid dispensing system of FIG. 5;

FIG. 7 is a side view of the module of the modular fluid dispensing system of FIG. 5;

FIG. 8 is a rear view of the module of the modular fluid dispensing system of FIG. 5 illustrating an electrical connector and a fluid connector according to one non-limiting embodiment;

FIG. 9 is a perspective view of at least one container configured to be positioned within the module of the modular fluid dispensing system of FIG. 1 according to one non-limiting embodiment;

FIG. 9A is a front view of another container configured to be positioned within the module of the modular fluid dispensing system of FIG. 1 comprising a selectable fluid dosing system according to one non-limiting embodiment;

FIG. 9B is an exploded view of the selectable fluid dosing system of FIG. 9A;

FIG. 9C is a front view of another container configured to be positioned within the module of the modular fluid dispensing system of FIG. 1 comprising another selectable fluid dosing system according to another non-limiting embodiment;

FIG. 10 is a perspective view of another container configured to be positioned within the module of the modular fluid dispensing system of FIG. 1 according to one non-limiting embodiment;

FIG. 11 is a top view of the at least one container of the modular fluid dispensing system of FIG. 1;

FIG. 12 is a front view of the at least one container of the modular fluid dispensing system of FIG. 11;

FIG. 13 is a side view of the at least one container of the modular fluid dispensing system of FIG. 11;

FIG. 14 is a perspective exploded view of an authentication portion of the at least one container of the modular fluid dispensing system of FIG. 1 according to one non-limiting embodiment;

FIG. 15 is a perspective view of an authentication portion positioned on the at least one container of the modular fluid dispensing system of FIG. 1 according to one non-limiting embodiment;

FIG. 16 illustrates a block diagram of the connectivity between the authentication portion of FIG. 15 and a portion of the machine of the modular fluid dispensing system of FIG. 1 according to one non-limiting embodiment;

FIG. 17 illustrates a block diagram of the machine and module of FIG. 1 according to one non-limiting embodiment;

FIG. 18 illustrates a block diagram of the connectivity between a fluid level detection system and a portion the machine of the modular fluid dispensing system of FIG. 1 according to one non-limiting embodiment;

FIG. 19 is a perspective view of the mounting of a fluid level detection system of the modular fluid dispensing system of FIG. 1 on the module according to one non-limiting embodiment;

FIG. 20 illustrates a flow chart for use of the authentication system and the fluid level detection system of the modular fluid dispensing system according to one non-limiting embodiment; and

FIG. 20A illustrates a continuation of the flow chart of the modular fluid dispensing system of FIG. 20A according to one non-limiting embodiment.

### DETAILED DESCRIPTION OF THE INVENTION

Various embodiments will now be described to provide an overall understanding of the principles of the structure, function, manufacture, and use of the apparatuses and methods disclosed herein. One or more examples of these embodiments are illustrated in the accompanying drawings. Those of ordinary skill in the art will understand that the apparatuses and methods specifically described herein and illustrated in the accompanying drawings are non-limiting example embodiments and that the scope of the various embodiments of the dispensing system is defined solely by the claims. The features illustrated or described in connection with one example embodiment may be combined with the features of other example embodiments. Such modifications and variations are intended to be included within the scope of the invention.

As technology advances, the shape and design of various machines can also change. In some instances, it may be desirable to design machines with modular components to allow specific portions of the machines to remain the same while redesigning and replacing only the portions affected by technology and/or design changes. According to various embodiments, a modular fluid dispensing system configured for use with a machine can comprise a module and at least one container, both configured such that the modular fluid dispensing system can be redesigned and/or replaced without having to change out and/or purchase a completely new machine. In such instances, the modular fluid dispensing system can enable improvements to be made to a modular fluid dispensing system of a machine without having to change the connections between the module and the machine and/or change the space requirements for the module within the machine. In such embodiments, the modular fluid dispensing system can also reduce the need to purchase a new machine merely because a modular fluid dispensing system on the machine is outdated. Instead, now, the modular fluid dispensing system can easily be replaced with an updated modular fluid dispensing system. In at least one embodiment, the various machines discussed herein can include appliances, such as washers, dryers, dishwashers, and/or any other suitable appliances or machines that can use at least one fluid, vapor, and/or a gas during an operating cycle. In other various embodiments, the machines can be used in car washes and/or in paint manufacturing, for example. In any event, the appliances or machines can be configured for residential and/or commercial use, for example.

In many circumstances, users may be required to add various products to the machines so that the machines can use the various products in an operating cycle, such as a cleaning cycle, for example. In at least one embodiment, the various products can be included in at least one cartridge or container, for example. In some instances, users may rather add product(s) to the machine one time and achieve the desired benefit for multiple cycles before having to add the product(s) again. In yet another embodiment dispensing of multiple products simultaneously can achieve additional benefits, for example two products that are at least partially incompatible (meaning that the products can denature or neutralize each other, or can form insoluble complexes which can settle out of solution) and must remain separated until time of use can be dispensed simultaneously into the cycle. Nonlimiting examples of at least partially incompatible products include: anionic detersive surfactants and cationic fabric softeners or fabric care polymers; bleach and fabric treatment additives such as softeners and perfumes. In addition, sequential cycles may require simultaneous dispensing on machines with multiple simultaneous cycles of operation, for example in a laundry context: using a detergent or cleaning composition in a wash cycle, followed by a softening or enhancing composition in a rinse, in a dishwashing context a cleaning composition followed by a finishing composition. In various embodiments, portions of the machines which are configured to receive the various products and/or the containers can be located on the top of the machines such that the containers can be inserted vertically within the portions of the machines. In some circumstances, it is believed that certain vertical insertion systems can suffer from undesirable product leaking while the containers are being inserted and/or removed from the portions of the machines owing to the force of gravity. In many instances, however, the top and sides of the machines may not be easily accessible to the user because of machine stacking and/or positioning along side of another machine and/or a wall, for example. In such instances, it can be desirable to allow the user to add the various products and/or the containers of the various products to the machines via the front face of the machine, for example. It can also be desirable to allow the user to insert the containers in a horizontal orientation to at least inhibit the various products from leaking during the insertion and/or removal of the containers from the machine.

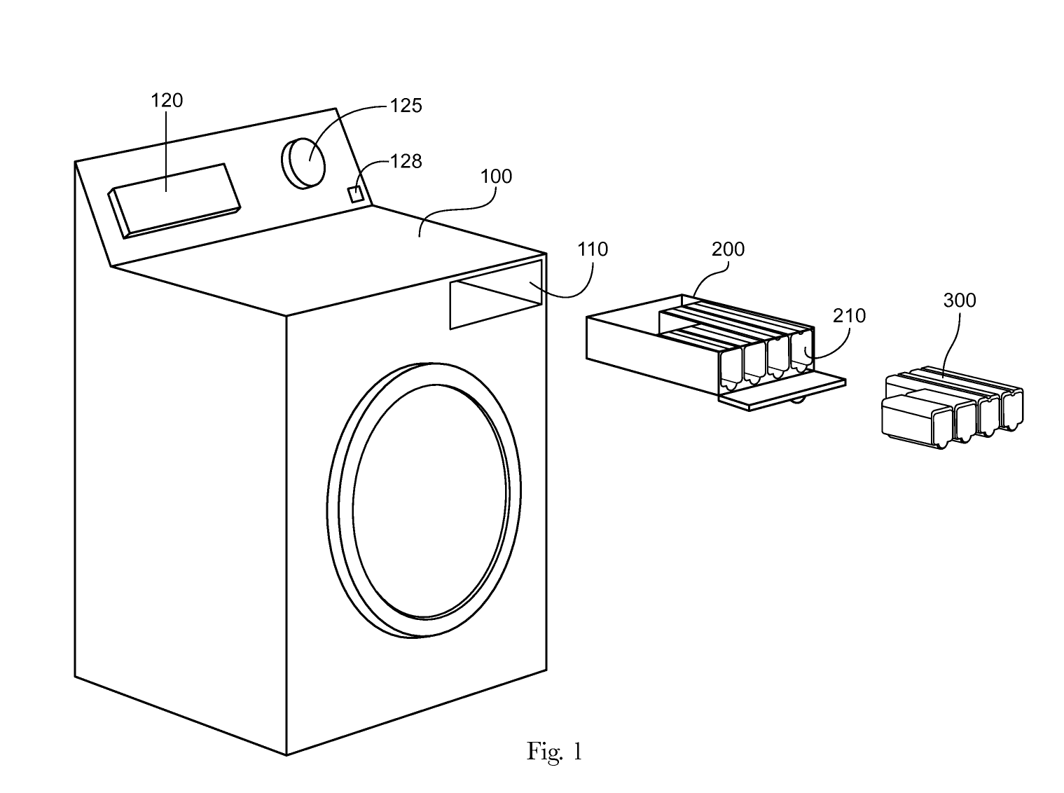

In various embodiments, referring to FIG. 1, a machine 100, such as an appliance, for example, can comprise an aperture 110 configured to receive a module 200. In at least one embodiment, the machine 100 can also comprise a display 120 configured to provide various output information about the machine 100, the module 200, and/or at least one container 300 to a user. In such embodiments, the machine 100 can also comprise an operation knob 125 configured to allow the user to set a particular operating cycle and an on/off switch 128 configured to turn the machine 100 on or off. In various embodiments, the module 200 can be configured to receive the at least one container 300. The at least one container can be configured to contain any suitable fluid, vapor and/or gas. a fluid, such as a detergent, a fragrance, a fabric softener, a soap, and/or any other suitable fluid, vapor, and/or gas. Those of skill in the art will understand that depending on application there are many different products that could be used. Nonlimiting examples of suitable fluid compositions include fabric care compositions (such as granular or liquid laundry detergents, liquid or power fabric enhancers, antistatic agents, bleaches, perfumes, color guards, stain prevention, wrinkle release, odor treatments, insect repellents, antifungal agents, and mixtures thereof); hard surface cleaning agents (such as liquid, powder or gel automatic dish washing compositions, dish finishers, and mixtures thereof, and car treatment compositions (such as liquid, gel or powder car wash detergent, waxes, polishes, water repellants, etc); and other surface treatment (such paints, primers, thinners, clear coats, base coats, metallic agents, etc). In at least one embodiment, the at least one container 300 can comprise more than one container (hereafter referred to as “container 300” regardless of whether a single or multiple containers are being discussed). In such an embodiment, each of the containers 300 can comprise a different fluid and/or a different product, for example. In other various embodiments, a container 300 can comprise more than one fluid and/or product, for example. In various embodiments, the module 200 and the container 300, in combination with various connections to the machine 100 positioned within the aperture 110, can comprise the modular fluid dispensing system.

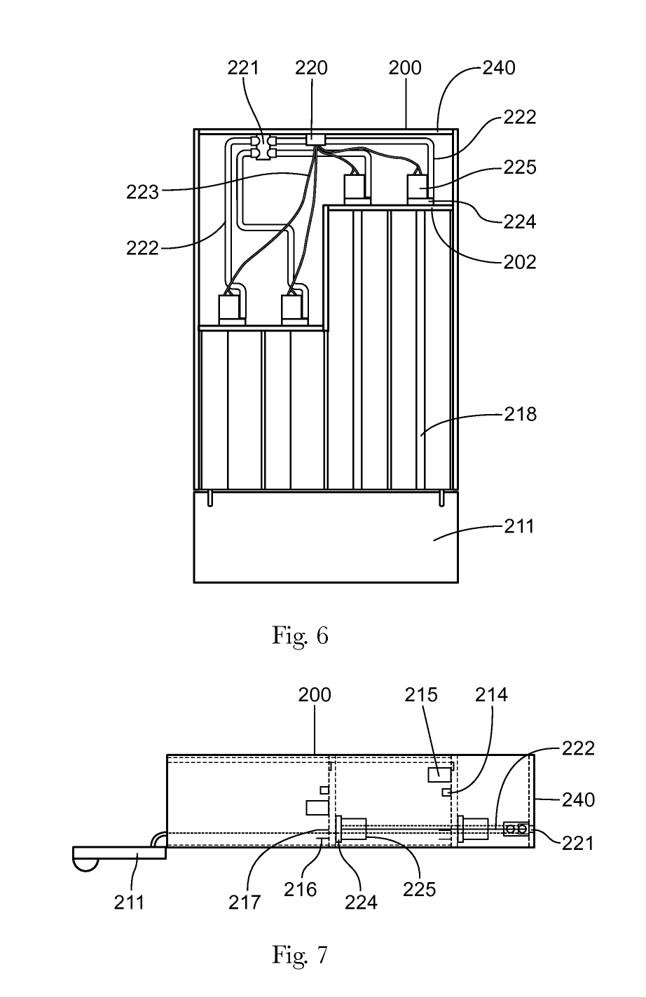

In various embodiments, referring to FIGS. 1-8, the module 200 can be configured to interface with at least one connector within the aperture 110 of the machine 100. In one embodiment, the module 200 can be eliminated and the container 300 can be configured to interface directly with the at least one connector within the aperture 110 of the machine 100, for example. In any event, the aperture 110, the module 200, and/or the container 300 can comprise standard fluid and electrical connections to enable to the module 200 and/or the container 300 to be easily changed out and/or replaced due to technological advances or user preferences, for example. In various embodiments, the apertures 110 in a plurality of the machines 100 can be standard such that a single module 200 could be used in each of the machines 100. In other various embodiments, the module 200 can comprise various features for a particular brand of a machine 100, for example, such that the modules 200 can be brand specific. In at least one embodiment, the modules 200 can have various mechanical and/or electrical features specific to a particular brand of machines 100, such that various modules 200 can only be used with the particular brand of machine 100, for example.

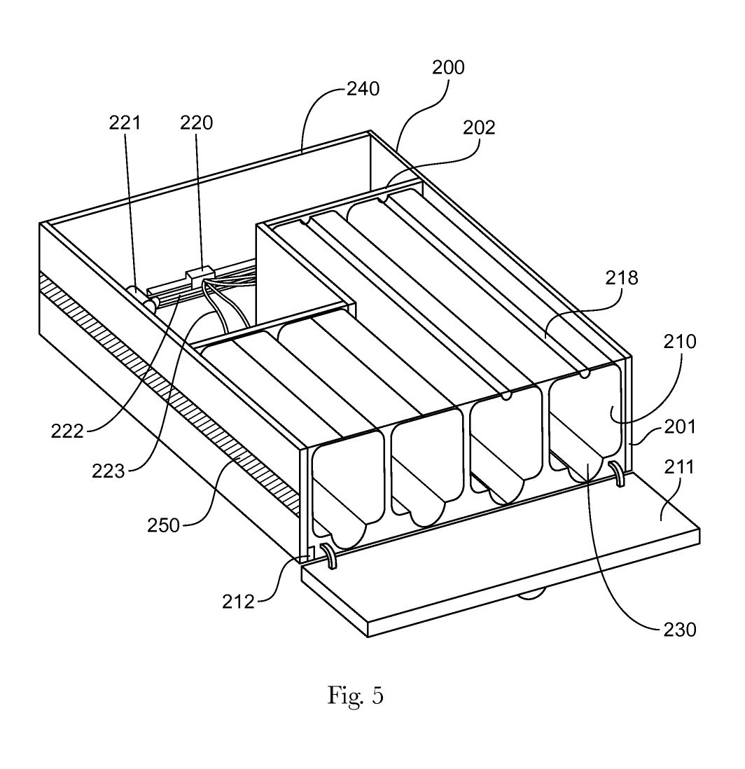

As technology changes, the machine 100 can be upgraded with a replacement module 200 configured to fit within the same space in the aperture 110 and can use the same electrical connection 220 and/or the same fluid connector 221 of the machine 100. Furthermore, the module 200 can enable the machine 100 to be upgraded without replacing the machine 100 interface to the module 200. In various embodiments, an electrical and/or a mechanical lock and key system between the module 200 and the machine 100 can enable each machine manufacturer to have an exclusive module 200 design for their specific brand to at least inhibit the possibility of another brand of module 200 being inserted into the wrong machine 100. For example the module can include a preprogrammed micro chip or radio frequency identification (RFID) tag as means of identification communication between the module and machine. In at least one embodiment, referring to FIGS. 4 and 5, a wall 130 of the aperture 110 can comprise a longitudinally oriented slot 140 and the module 200 can comprise a longitudinally oriented projection 250. In such an embodiment, the longitudinally oriented projection 250 can be configured to be at least partially engaged with the longitudinally oriented slot 140 when the module 200 is positioned within the aperture 110. In other various embodiments, any suitable lock and key type interlocking features and/or other suitable interlocking features, such as projections and slots and/or ridges and recesses, for example, can be included on the module 200 and/or on the walls 130 of the aperture 110 to create an interlocking engagement between the module 200 and the aperture 110, for example. As discussed above, these various lock and key features can be brand specific or can be standard for all, or most, machines, for example.

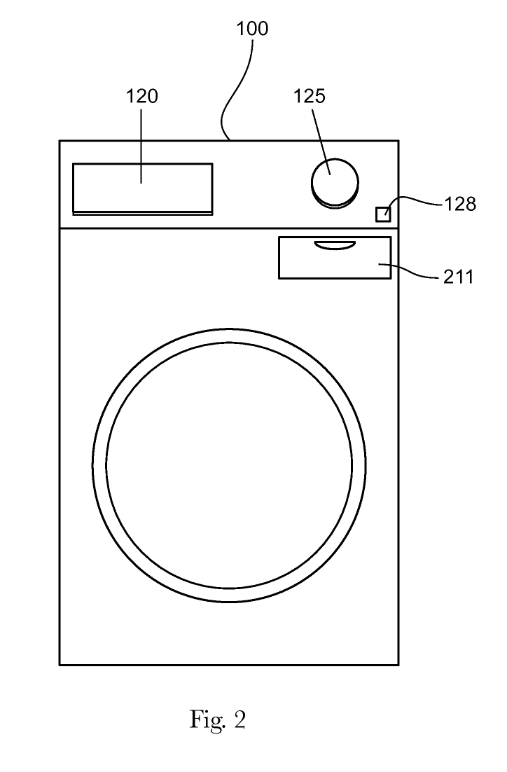

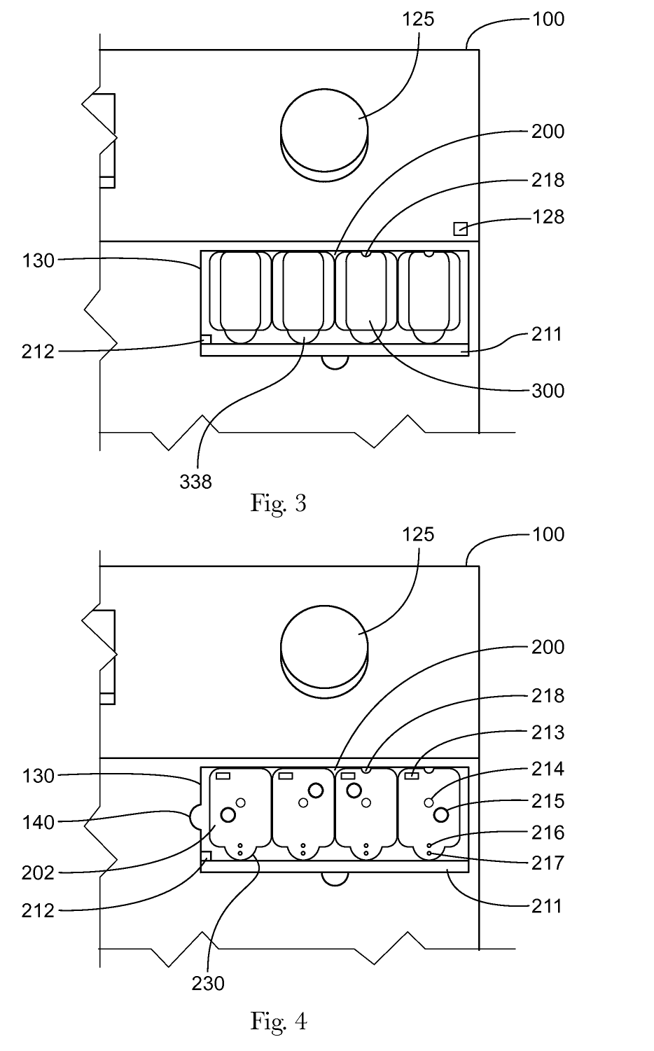

In various embodiments, referring to FIGS. 2-5, the module 200 can comprise a module door 211 movable between an open position (see e.g., FIGS. 3-5) and a closed position (see e.g., FIG. 2). In various embodiments, the module door 211 can be opened to insert and/or remove the container 300 from the module 200. In at least one embodiment, the module door 211 and a module doorway 201 can be engaged with and/or can comprise a safety interlock switch 212. In such an embodiment, the modular fluid dispensing system may not be activated until the module door 211 is in the fully closed position and the container 300 is properly positioned within the module 200. In various embodiments, the safety interlock switch 212 can eliminate, or at least reduce, the possibility that the modular fluid dispensing system will be activated if the container 300 is not properly positioned within the module 200 and/or an improper container is positioned within the module 200, for example. In various embodiments, the safety interlock switch 212 can comprise a mechanical component configured to produce an audible sound, such as a clicking, a snapping, and/or an engaging sound, for example, to indicate to the user that the module door 211 is in the fully closed position and that the container 300 is positioned properly within the module 200. In other various embodiments, the display 120 on the machine 200 can indicate the status of the module door 211 to the user.

In various embodiments, referring to FIGS. 1 and 3-5, the module 200 can comprise at least one receiving chamber 210 configured to receive the container 300. In at least one embodiment, the module 200 can comprise a plurality of receiving chambers 210, each configured to receive a container 300. In such an embodiment, at least one of the receiving chambers 210 can comprise a different orientation and/or a different configuration such that only particular containers 300 will be suitable for use with that particular receiving chamber 210. In various embodiments, the receiving chambers 210 can comprise different geometries, different lengths, and/or different dimensions such that only particular containers 300 will fit within the various receiving chambers 210. In one embodiment, two of the receiving chambers 210 can comprise a recess and/or an engagement key 218 on a wall thereof. In such an embodiment, at least some of the containers 300 can comprise complimentary features, such as a recess and/or a projection, for example, such that the containers 300 can only be positioned within particular receiving chambers 210, for example. Such receiving chambers 210 can prevent, or at least inhibit, a user from placing the wrong container 300 into the wrong receiving chamber 210, for example. The receiving chambers 210, via the various lock and key features, can also at least inhibit the wrong fluid from being dispensed at a wrong time during a cycle and/or to the wrong portion of the machine 100 by denying the insertion of a wrong container into a particular receiving chamber 210. The module 200 can comprise any suitable number of receiving chambers 210 configured to receive any suitable number of containers 300, depending on the user's needs and product requirements for a particular machine 100. The containers 300 and/or the walls of the receiving chambers 210 can also comprise various lock and key features and/or other suitable features configured such that the containers 300 can only be inserted in the proper orientation, e.g., upright vs. upside down. In another embodiment, the various receiving chambers 210 and the various containers 300 can comprise corresponding, numbering, lettering, coding, color coding, and/or any other suitable indicia, such that the various containers 300 can be easily matched with the correct receiving chambers 210 by the user.

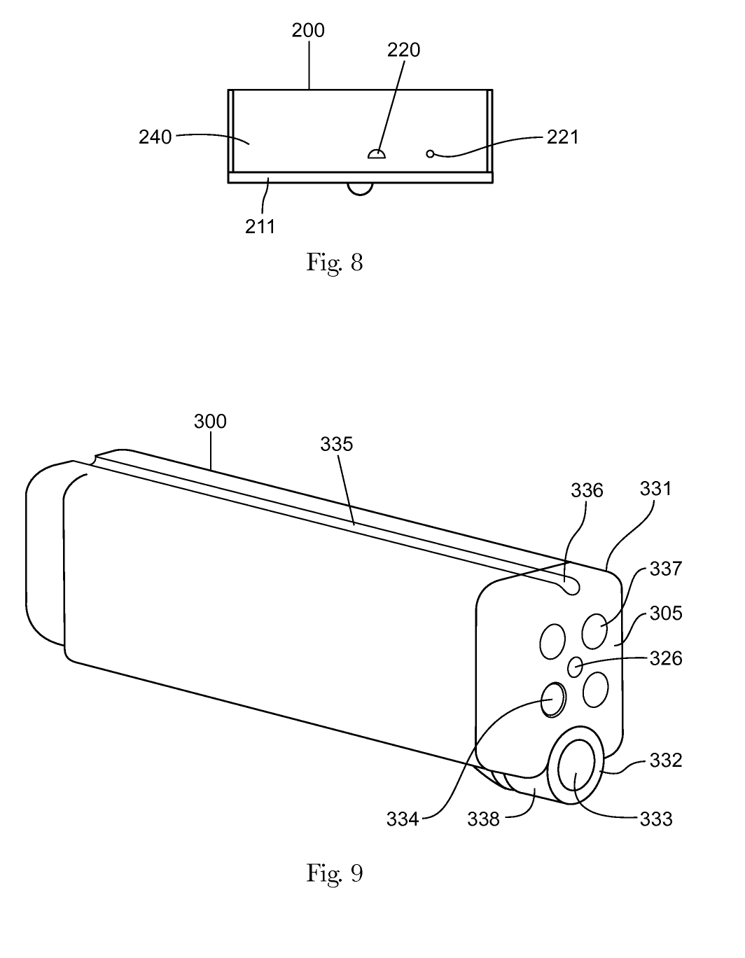

In various embodiments, referring to FIGS. 5-8, the module 200 can also comprise an electrical connector 220 and a fluid connector 221, or a series of fluid connectors and electrical connectors for example. In one embodiment, the electrical connector 220 and the fluid connector 221 can be configured to plug into and/or engage a fluid connector receiver on the machine 100 and/or within the aperture 110 and an electrical connector receiver on the machine 100 and/or within the aperture 110, respectively. The module 200 can easily be replaced with another module 200 without replacing the entire machine 100, owing to the standard electrical and fluid connectors 220 and 221. In one embodiment, the fluid connector receiver can be in fluid communication with a fluid-receiving portion of the machine 100 and, likewise, the electrical connector receiver can be in electrical communication with a power source to and/or of the machine 100. Said at least one fluid can be extracted from the container 300 via the fluid connector 221 and provided to the machine 100. Similarly, electrical power can be supplied by the machine 100 to the module 200 via the electrical connector 220. Further to the above, referring to FIGS. 5-7, tubing 222 can be positioned within the module 200 to place the fluid connector 221 in fluid communication with the at least one fluid within the container 300 and/or in fluid communication with at least one pump 224 positioned within the module 200. Similarly, wires 223 within the module 200 can be in electrical communication with the electrical connector 220 and the at least one pump 224 and/or at least one motor 225 within the module 200. In such embodiments, the at least one motor 225 can power the at least one pump 224 to cause the at least one pump 224 to withdraw the at least one fluid from the container 300. In at least one embodiment, a plurality of pumps 224 and/or motors 225, electrical connectors 220, and fluid connectors 221 can be provided within the module 200 and/or the machine 100. Various valves can be positioned within the tubing 222 and/or at the ends of the tubing 222 to allow the at least one pump 224 to withdraw the at least one fluid from a first container and/or withdraw the at least one fluid from a second container, for example. In one embodiment, the at least one motor 225 can be included in the at least one pump 224, for example. In another embodiment, the electrical connector 220 and the fluid connector 221 can comprise one port and/or a plurality of ports on the module 200, for example. One embodiment of a rear wall 240 of the module 200 comprising the electrical connector 220 and the fluid connector 221 is illustrated in FIG. 8.

In various embodiments, referring to FIG. 4, the at least one pump 224 can be in fluid communication with at least one fluid tube configured to puncture and/or pierce at least a portion of the at least one container 300. In one embodiment, the at least one fluid tube can comprise a fluid vent tube 216 and a fluid extraction tube 217. The fluid vent tube 216 and the fluid extraction tube 217 can both puncture a self-sealing mechanism located on the container 300, when the container 300 is positioned within the receiving chamber 210. In such a configuration, the fluid extraction tube 217 can withdraw the at least one fluid from the at least one container 300 as the fluid vent tube 216 flows a fluid and/or a gas into the container 300. In such an embodiment, the fluid vent tube 216 can at least inhibit a substantial vacuum from forming within container 300 to aid in the fluid extraction. Container 300 can be pressurized and the fluid vent tube 216 can be eliminated and/or not used, for example. In any event, motor 225 can power the at least one pump 224 to cause the at least one pump 224 to create suction within the fluid extraction tube 217 and thereby withdraw the at least one fluid from the container 300. In such an embodiment, the pump 224 can be configured to then pump the at least one fluid into the tubing 222, through the fluid connector 221, to the fluid connector receiver, and to a fluid-receiving portion of machine 100.

There are many manufacturers of counterfeit or “knock-off” fluid containers. Further, there is a chance that a user and/or a counterfeit container manufacturer may refill an authentic container 300 and reuse the container 300 multiple times in the machine 100. This can result in financial losses to the manufacturer of the authentic container 300. Also, there is a chance that the performance of the machine 100, such as the wash quality of clothes, for example, may deteriorate, if a counterfeit container and/or a refilled container is loaded into the receiving chamber 210 of the module 200. Furthermore, this counterfeiting can also potentially lead to a lowering of the brand image of the manufacturer of the authentic container 300 and/or the machine 100, for example.

In view of the above-discussed issues, in various embodiments, the receiving chambers 210 and/or the containers 300 can comprise various interlocking and/or lock and key features configured to prevent, or at least minimize opportunities for, inserting a counterfeit and/or improper container into the receiving chamber 210. In various embodiments, referring to FIGS. 1, 4-6, and 9, the containers 300 can comprise a receiving aperture 334 in a face 305 thereof with the receiving chambers 210 comprising at least one projection and/or receiving post 215 extending from a rear wall 202 of the module 200 or vice-versa, for example, such that the aperture 334 of the container 300 can be engaged with the at least one projection or receiving post 215. In another embodiment, each receiving chamber 210 can comprise a different length and/or a different dimension corresponding to only an authentic container 300 and/or a particular type of container 300, for example. The authentic container 300 having complimentary features may be able to be inserted into that particular receiving chamber 210 and interlock and/or engage with the various features of the receiving chamber 210. The modular fluid dispensing system can also comprise the ability to electrically authenticate the container 300, as discussed below.

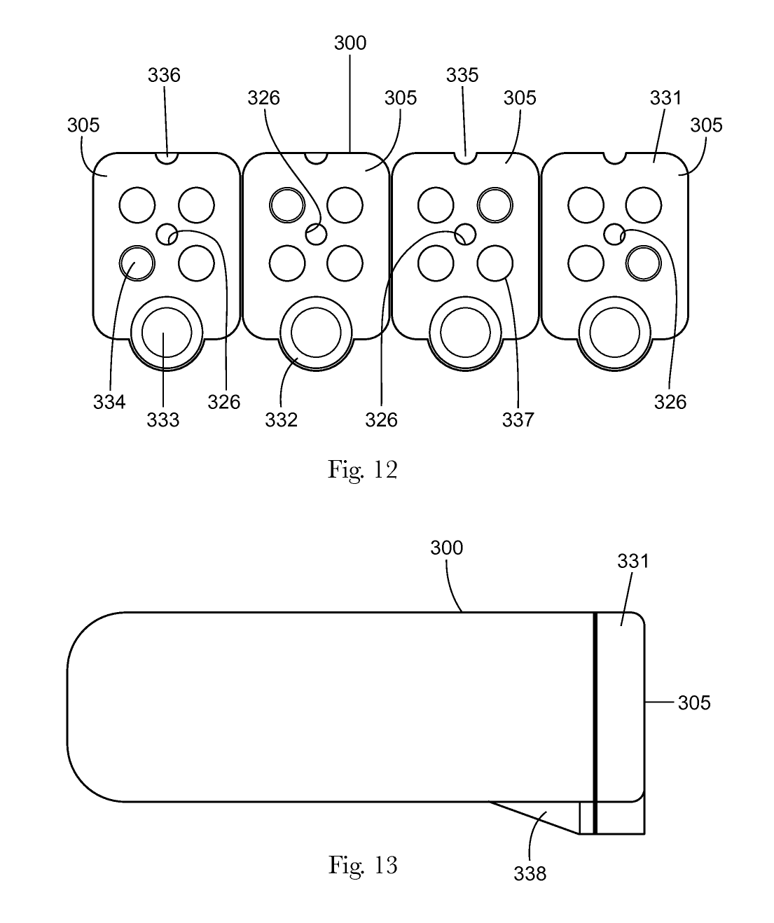

In various embodiments, referring to FIGS. 4, 5, 9, 10, and 12, the rear wall 202 of the receiving chamber 210 and/or the rear wall 240 of the module 200 can comprise the fluid vent tube 216, the fluid extraction tube 217, an electronic communicator 213, an indicator post 214, and/or at least one receiving post 215. In various embodiments, the electronic communicator 213 can be part of the container authentication system, as discussed in further detail below. In one embodiment, the indicator post 214 can extend from the rear wall 202 and can be configured to be engaged with, press-fit into, and/or snap-fit into an aperture 326 in the face 305 of the container 300 or closure 331 to provide the user with an audible and/or tactile indication that the container 300 has been fully engaged with the indicator post 214 extending from the rear wall 202. The container 300 can comprise an indicator post and the rear wall 202 can comprise an aperture, for example. The rear wall 202 can also comprise the at least one receiving post 215 configured to be engaged with the receiving aperture or apertures 334 on the face 305 of the container 300. In one embodiment, the rear wall 202 can comprise a receiving post 215 in each of a plurality of receiving chambers 210. In such an embodiment, referring to FIG. 4, various receiving posts 215 can be positioned at a different location on at least some of the rear walls 202 of the receiving chambers 210, such that only a container 300 having a complimentary receiving aperture 334 in the same or a similar location on the face 305 thereof can be engaged with the receiving post 215. In this fashion, the receiving posts 215 in the various receiving chambers 210 can at least inhibit the user from positioning the container 300 in the wrong receiving chamber 210. Furthermore, if the wrong container is positioned within the wrong receiving chamber 210, the face 305, instead of the receiving aperture or apertures 334 can engage the receiving post 215, thereby inhibiting the container 300 from being fully positioned within the receiving chamber 210 and, therefore, preventing the module door 211 from fully closing. As the module door 211 cannot fully close, the safety interlock switch 212 will not be activated, thus not activating the modular fluid dispensing system.

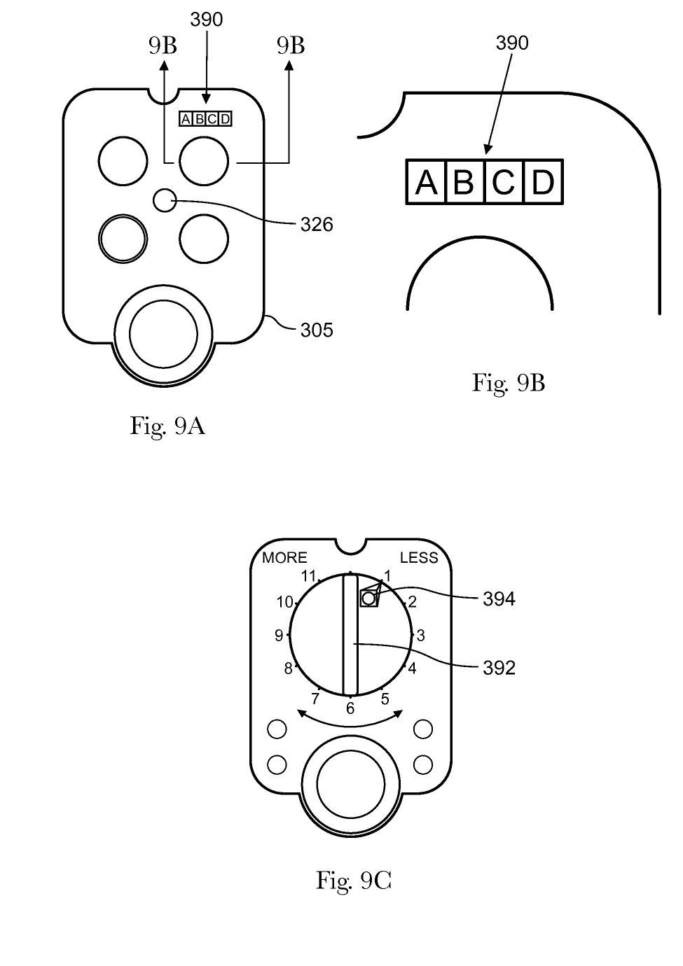

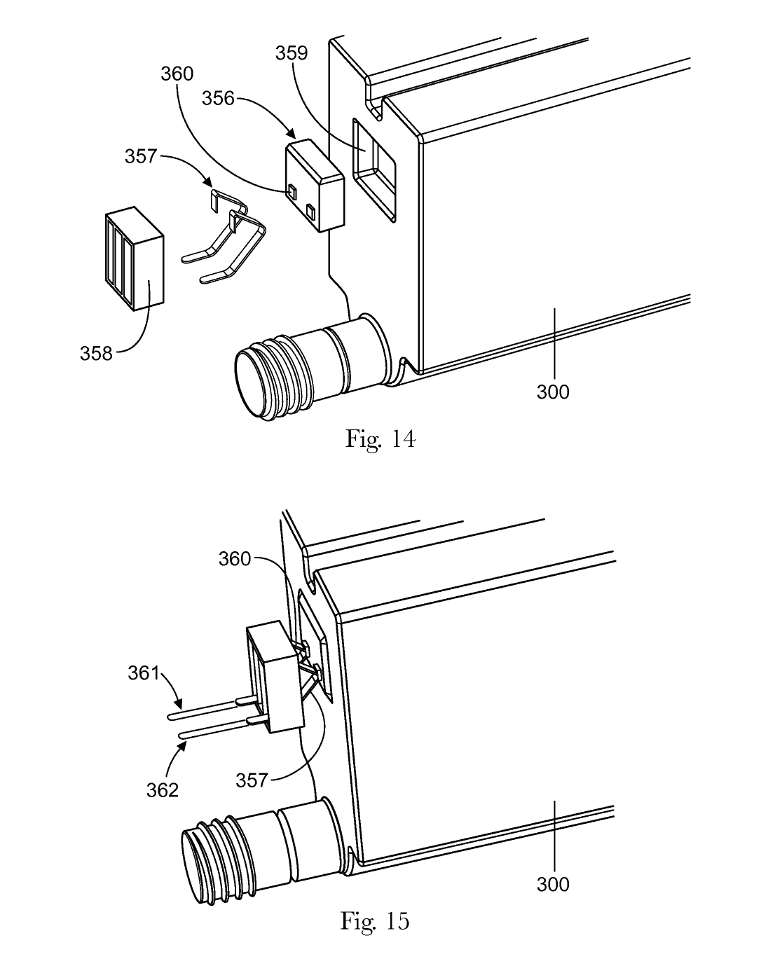

In various embodiments, referring to FIGS. 9 and 10-13, various container 300 configurations are illustrated. In at least one embodiment, the various containers 300 described herein can be formed of a rigid material, such as a blow molded plastic, for example. In other various embodiments, the containers 300 can be formed of a semi-rigid material and/or a non-rigid material, such as cardboard and/or plastic, for example. In other various embodiments, the containers 300 can comprise a bag-in-bottle configuration, wherein the bag can collapse within the container 300 during fluid evacuation from the bag, which can eliminate the need to include the fluid vent tube 216, for example. One container 300 can comprise a closure 331 configured to be reusable on various containers 300. In one embodiment, the closure 331 can be injection molded and can comprise the face 305, the receiving apertures 334, and the aperture 326. In various embodiments, a plurality of receiving apertures 334 can be positioned about the face 305. In at least one embodiment, receiving aperture plugs 337 can be positioned in at least some of the receiving apertures 334 depending on the location and/or orientation of the receiving post or posts 215 on the rear wall 202 of the receiving chamber 210, for example. The closure manufacture can remove and re-insert the receiving aperture plugs 337 to configure a particular container 300 for insertion into another receiving chamber 210 thus enabling the same closure to be used for different product containers and still be exclusive to one specific receiving chamber. In various embodiments, the closure 331 can also comprise a cap 332 comprising a self-sealing mechanism 333, for example. The at least one fluid can be extracted from the container 300 through the self-sealing mechanism 333, when the self-sealing mechanism 333 is punctured by the fluid extraction tube 217, and optionally by the fluid vent tube 216. In various embodiments, the self-sealing mechanism 333 can comprise a silicon material configured to seal after being punctured by the fluid vent tube 216 and the fluid extraction tube 217, for example.

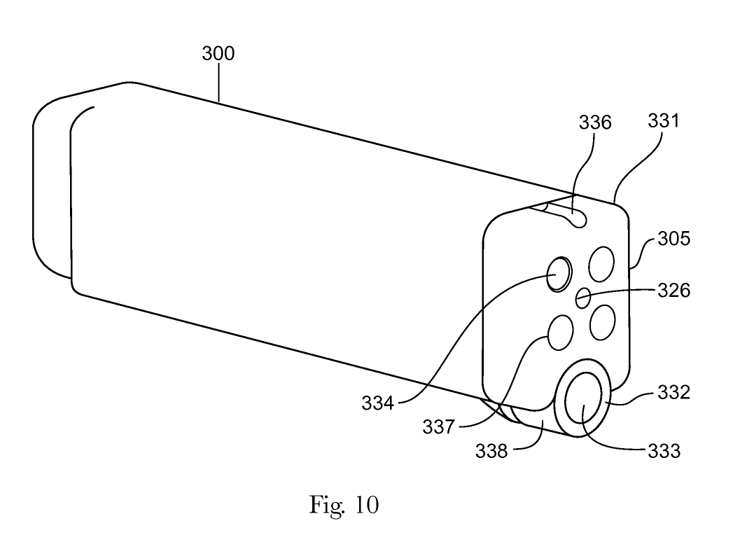

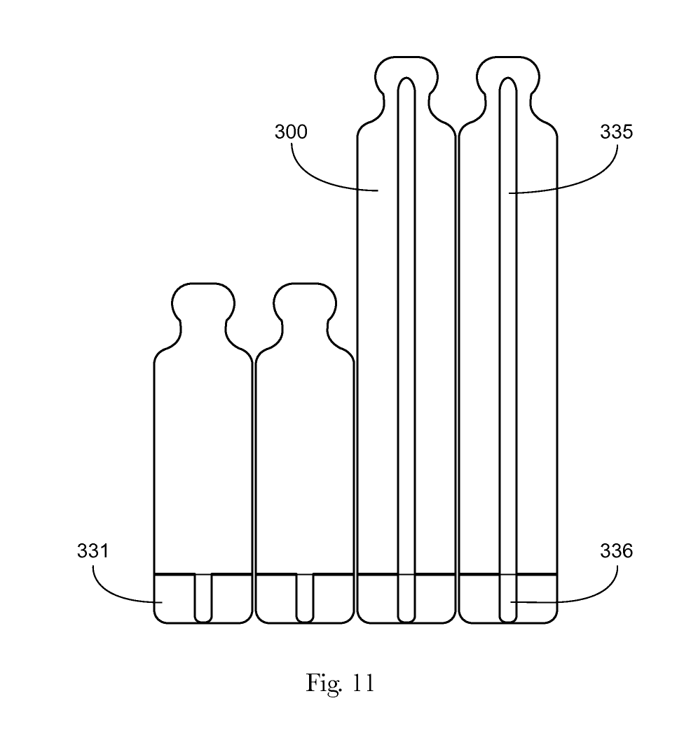

In various embodiments, referring to FIGS. 9 and 10-13, the various containers 300 can comprise an engagement key slot 335 and a closure key slot 336. In at least one configuration, the engagement key slot 335 can be aligned with the closure key slot 336, for example. In at least one embodiment, to prevent, inhibit, or at least minimize the opportunity of, the containers 300 of a shorter length (see e.g., FIGS. 10 and 11) from entering a longer receiving chamber 210, an engagement key 218 (see e.g., FIG. 4) can be located proximate to the module doorway 201 and within the longer receiving chambers 210. As illustrated in FIGS. 9 and 11, a corresponding engagement key slot 335 can be located on a top side of the longer containers 300, which can optionally travel the length of the top side of the longer containers 300, for example, to enable full engagement of the containers 300 to the receiving slot 210. In various embodiments, referring to FIGS. 10 and 11, the shorter containers 300 may not have an engagement key slot 335 thereby preventing, inhibiting, or at least minimizing the opportunity of, the shorter containers 300 from being inserted into the longer receiving chambers 210. In at least one embodiment, the closure key slot 336 can be used to aid the user in determining which portion of the container 300 should face upwardly and/or downwardly when inserted into the module 200 and/or the receiving slot 210. In various embodiments, referring to FIGS. 4, 5, 9, 10, and 13, the container 300 can also comprise an orientation lug 338 configured to again assist the user in determining which portion of the container 300 should face upwardly and/or downwardly, for example, when inserted into the module 200 and/or the receiving slot 210. In various embodiments, the orientation lug 338 can be engaged with a lug receiving portion 230 of the receiving slot 210.

In some instances, users may prefer to have control of an end result of the machine 100 experience. In addition, users may prefer to have the ability to customize the products and/or the fluids being used by their machine 100 to meet their specific desires. Therefore, a container 300 that can be customizable to meet the user's specific needs and/or improve performance of the machine 100 is desirable and can enhance the user's experience. The customizable container 300 can also allow the users to set their own standard of performance by interacting with the container 300, for example. In various embodiments, the container 300 can comprise a selectable fluid dosing system comprising a user activation member configured to allow the user to select the dose most appropriate for a particular cycle of the machine 100. In other various embodiments, including a multi-fluid container 300, the user activation member can allow the user to select the products and/or the fluids most appropriate for a particular cycle of the machine 100. In one embodiment, referring to FIGS. 9A and 9B, the user activation member of the container 300 can comprise peel away tabs 390, labeled A, B, C, and D, for example. After the user peels away one or more tabs 390 from the container 300, the user can then insert the container 300 into the receiving chamber 210 of the module 200. Module 200 can comprise a fluid dosing system reader configured to determine which tab(s) 390 the user has peeled away and, thereby, instruct the fluid dosing system to extract the appropriate product and/or fluid, and/or an appropriate dose amount of the product and/or the fluid, from the container 300. In one embodiment, the fluid dosing system reader can be in electrical communication with a microcontroller configured to instruct the pump 224 and/or the motor 225 how much fluid and/or product as well different combinations of products to extract from the container(s) 300.

In other various embodiments, when the user peels away one or more of the tabs 390, one or more electrical contacts on the container 300 can be exposed. In such an embodiment, when the user inserts the container 300 into the receiving chamber 210 of the module 200, the one or more electrical contacts can be placed in electrical communication with at least one module contact on the module 200 to complete a circuit with the pump 224 and/or the motor 225 and allow the fluid dosing system to extract the appropriate fluid and/or product, and/or the appropriate dose amount of the fluid and/or the product, from the container 300. In yet another embodiment mechanical actuator vs. electrical actuators may be preferred or combination of mechanical and electromechanical actuators used. In still other various embodiments, the user activation member can comprise a slidable cover configured to be positioned over the one or more of the tabs 390 such that the user can expose an appropriate one or more electrical contacts to at least one module contact on a portion of the module 200 to place the one or more electrical contacts in electrical communication with the at least one module contact and allow the fluid dosing system to extract a fluid and/or a product from the container 300 based on the consumers customized and preferred settings.

In various embodiments, still referring to FIGS. 9A and 9B, tab A can relate to the normal fluid dose, while tab B can relate to two times the normal fluid dose, for example. In at least one embodiment, tab C can relate to dispensing another product and/or fluid in conjunction with the standard product and/or fluid being dispensed. As such, when tab C is exposed, the fluid dosing system can dose multiple products simultaneously, for example. This type of dosing can be beneficial for an active product or fluid that should only be mixed with another product and/or fluid at the time of use. In various embodiments, tab D can relate to when the fluid dose is dispensed during the cycle (e.g. middle of cycle), for example. In other various embodiments, the tabs 390 can be configured to cause multiple fluids and/or products to be withdrawn from the container 300 and provided to the machine 100 to create a user preferred scent, for example. In at least one embodiment, the electrical contacts located on the container 300 and/or the closure 331 of the container 300 can comprise printed circuit boards and/or customizable microchips. In such embodiments, the printed circuit boards and/or the customizable microchips can be configured to send different control algorithms to the module 200 and/or a microcontroller of the machine 100. In various embodiments, the module 200 can use the same type of customizable design to enable the module 200 to be customized to meet specific user needs on different machines using a similarly sized, or the same sized, module 200, for example.

In further various embodiments, referring to FIG. 9C, the user activation member of the selectable fluid dosing system can comprise a rotatable dial 392 having an aperture 394 therein. In such an embodiment, the rotatable dial 392 can be rotated by the user to expose at least one electrical contact situated behind the rotatable dial 392. In such an embodiment, the exposed electrical contact can indicate to the fluid dosing system the dose amount, and/or which product and/or fluid, should be extracted from the container 300. In at least one embodiment, the dose settings can comprise a range, where a low setting can instruct the module 200 to extract the least amount of fluid from the container 300 and where a high setting can instruct the module to extract a greater amount of fluid from the container 300, for example. In other various embodiments, any other suitable fluid dosing system that can allow user customization can be included on the container 300.

In other various embodiments, the module 200 can comprise the selectable fluid dosing system and/or the user activation member, for example. In such an embodiment, the selectable fluid dosing system and the user activation member can be similar to that described with respect to the container 300. In such an embodiment, as the user peels away a tab, slides a cover, and/or rotates a dial, for example, the module 200 can instruct the fluid dosing system to withdraw a particular dose amount of fluid, and/or a particular fluid or product, from the container 300.

As discussed above, container counterfeiting can cause the machine 100 to not function at an optimal level and/or can cause the machine 100 to run an operating cycle which does not live up to the user's expectations, sometimes owing to the non-authentic products and/or fluids within the counterfeit container. To prevent, or at least inhibit, container counterfeiting, even container counterfeiting using containers having a configuration suitable to fit into the receiving portion 210 of the module 200, the modular fluid dispensing system and/or the module 200 can comprise a container authentication system comprising a reader, such as a bar code, radio-frequency identification (RFID) tag reader, or printed circuit label reader, for example. In various embodiments, the container 300 can comprise an authentication portion, such as a readable tag and/or printed circuit label, thereon configured to be read by the reader. In one embodiment, the authentication can be exposed on the surface of the container or can be non-exposed. In such an embodiment, only containers 300 produced by the authentic container manufacturer may cause the modular fluid dispensing system to operate. If the reader determines that the authentication portion and/or readable tag of the container 300 is a counterfeit and/or does not exist, the modular fluid dispensing system may not extract fluid from the container 300, for example. In one embodiment, the authentication system comprises mechanical elements such as a male member on the container and female receiving area on the module to detect when the container is present, or vice versa. Non-limiting examples of mechanical systems include the cams disclosed in U.S. Provisional Patent Appl. No. 61/099,602.

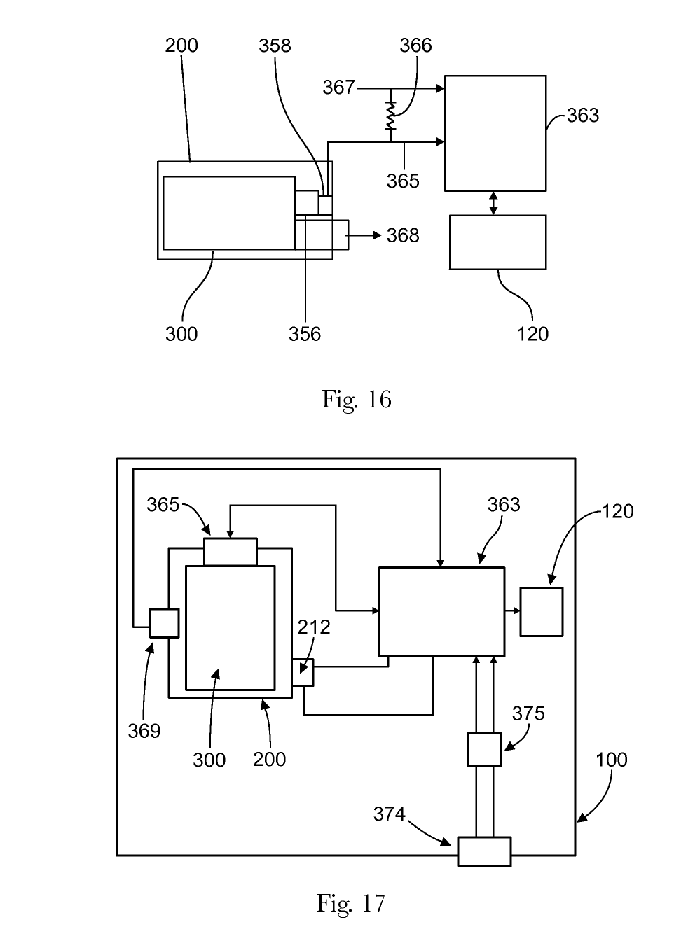

In various embodiments, referring to FIG. 14, the container 300 can have a recess 359 configured to retain an electromechanical single flat no lead (SFN) module 356. An SFN module is commercially available by Dallas Semiconductor Maxim and may comprise a 1 k-bit protected 1-wire electrically erasable programmable read only memory (EEPROM). In at least one embodiment, the 1 k-bit EEPROM comprises 1 k-bit of information portion regarding the container 300 with a 64-bit write only secret data portion. The chip can be a Dallas Semiconductor 1-wire DS2432P that reads and writes over a wide voltage range of 2.8 V to 5.25 V, for example. In various embodiments, the microprocessor within the chip can communicate at up to 16.3 k-bits per second. In at least one embodiment, a 1-wire DS2432P may comprise a 1 k-bit protected 1-wire EEPROM. A 1128-bits portion of 5 V EEPROM memory may be partitioned into four pages of 256 bits. In various embodiments, the 64-bit portion can hold up to five general purpose read/write registers. In various embodiments, a unique 64-bit registration number can assure traceability of the container 300. In at least one embodiment, the SFN module 356 can comprise two terminals 360, such as copper terminals, for example, that can contact terminals 357 of a terminal housing 358 in the module 200 when the container 300 is inserted into the receiving chamber 210. As illustrated in FIG. 16, the copper terminals 357 can be connected to the microcontroller 363 by a wire 365, for example. In at least one embodiment, a 1-wire master can typically be used on the machine 100 data processing unit with the microcontroller 363. In various embodiments, the microcontroller 363 can control the read/write functions of the 1 k-bit EEPROM. In at least one embodiment, the data processing unit of the microcontroller 363 can sense the presence of the container 300 and send a request for the data. Since the EEPROM has 1 k-bit of data memory, the data can be comprised of manufacturing information such as serial numbers, date codes, and/or any other suitable information, for example. The steps involved in accessing the device can be initialization, read only memory (ROM) function command, memory function command, and data transfer. The data on the chip is the authorized machine authentication code (MAC) generated as secret proprietary data and information. The EEPROM does not require an external power supply as it derives power from the 1-wire data pin 367. The container authentication status of the container 300 is then displayed on the display 120

In addition to the above, there is a chance that the user will not have any information pertaining to the fluid level of the container 300 in the machine 100 and may run the machine 100 with an empty container 300, possibly resulting in an ineffective operating cycle. As a means to eliminate this type of misuse, the container 300 and the machine 100 can interact within each other to determine if there is enough fluid remaining in the container 300 to run an effective operating cycle. In various embodiments, this can require that the container 300 and the machine 100 have the capacity to determine that no counterfeit container is being used in the machine 100 and that no refilling of the container 300 has been performed. In at least one embodiment, the modular fluid dispensing system can comprise a fluid level detection system configured to determine a fluid level within the container 300. In other various embodiments, the fluid level detection system can ensure that once a container 300 has been used on the machine 100, the same container 300 may not be able to be used on any other machine 100, for example. Various fluid level detection techniques for containers (i.e. a capacitance fluid level detection system, a load cell, ultrasonic transducers, and/or optic, LED, light sensing systems) have been described in U.S. Provisional Patent Appl. No. 61/099,602, entitled METHODS AND APPARATUSES FOR DISPENSING FLUIDS, to Smith et al., filed on Sep. 24, 2008, hereby incorporated by reference in its entirety.

Referring to FIG. 17, an example circuit diagram of the machine 100 is illustrated. In various embodiments, the fluid level detection system can comprise an ultrasonic fluid level sensor 369 positioned and configured to read the fluid level within the container 300 and then relay the fluid level information to the microcontroller 363 or other suitable controller. In at least one embodiment, a data communication cable 365 in contact with the container 300 may be in electrical communication with the microcontroller 363 to relay information about the container and its contents to the microcontroller 363. Examples of this information includes: determines the number of uses that have been extracted from the container by recording the each product extraction into the container memory. This will disable the container to function even if all registration codes match due to the memory having exceeded the maximum number of product extractions preprogrammed by the manufactures. In various embodiments, the safety interlock switch 212, described above, can be in electrical communication with the microcontroller 363 to indicate to the microcontroller 363 when a container 300 is properly positioned within the module 200. In other various embodiments, the display 120, the operation knob 125, and the on/off switch 128 can be in electrical communication with the microcontroller 363 to relay information about the on/off switch 128 and the operation knob 125 to the microcontroller 363 and/or to relay information about the machine 100 to the display 120, for example. In various embodiments, the on/off switch 128 can be in electrical communication with both a power source such as a power supply 374 and the microcontroller 363, such that the power supply 374 can provide power to the microcontroller 363 when the on/off switch 128 is in the “on” position.

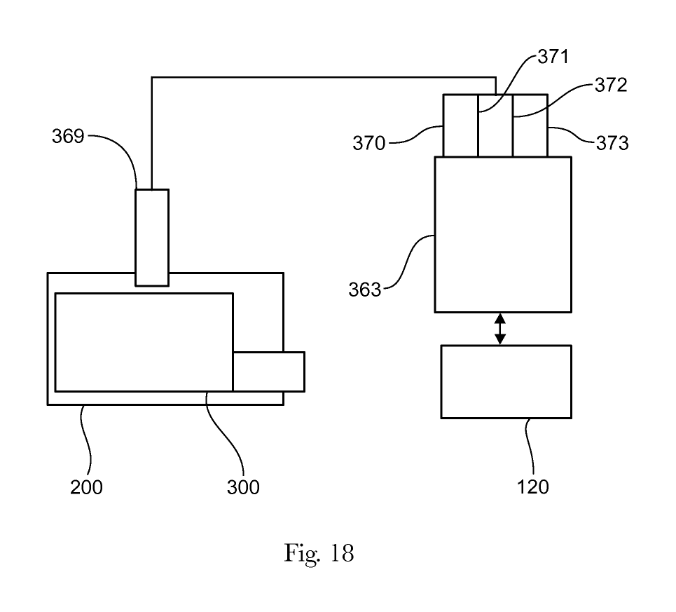

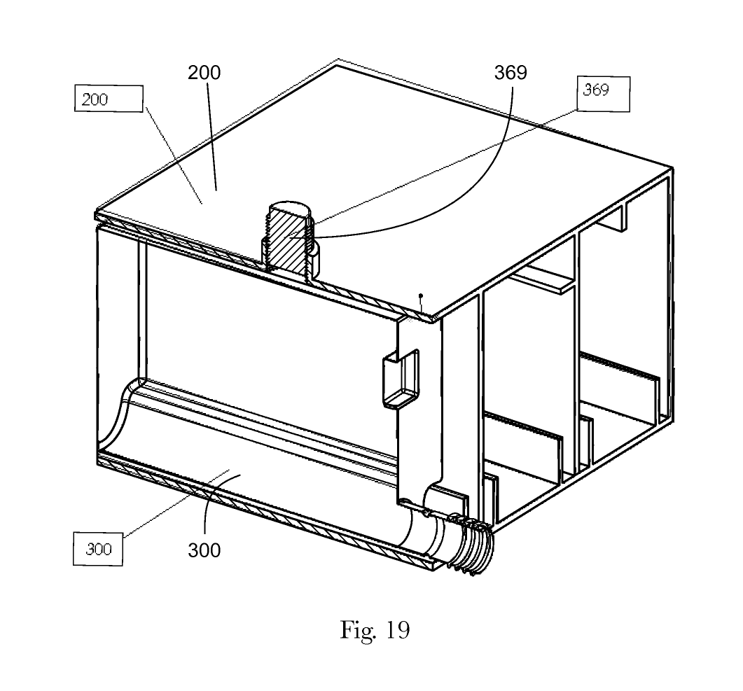

In various embodiments, referring to FIG. 19, the ultrasonic fluid level sensor 369 can be mounted to the module 200 such that the sensor 369 is proximate to the container 300, and more specifically, such that it can detect the fluid level of the container 300. In one embodiment, the ultrasonic fluid level sensor 369 can be range and/or distance sensitive enabling the sensor 369 to detect the fluid level only within a desired range. A built in indicator such as a light source, and in one embodiment a light emitting diode (LED) indicator, for example, can be illuminated when the fluid level inside the container 300 is within a predetermined range. An ultrasonic wave from the sensor 369 is transmitted through the container 300 wall and is reflected back to the sensor 369 by the fluid inside the container 300. The indicator is illuminated when the reflected ultrasonic wave is within a preset range, which is indicative of the fluid level being within a predetermined range. In at least one embodiment, the preset sensing range can be adjusted by connecting a range adjustment wire to a ground and/or to a potentiometer or a resistor to allow a machine manufacturer to input a specific preset distance that correlates to a specific module 200 and/or a specific machine 100. In various embodiments, the sensor 369 can sense fluid level precisely regardless of color, density, and/or transparency of the container 300. In various embodiments, referring to FIG. 18, an output wire 371 can be used for the data processing and control via the data processing unit of the microcontroller 363. In at least one embodiment, a wire 372 can provide 30 V DC power to the microcontroller 363. In such an embodiment, a wire 373 can be configured to provide the synchronization enabling signal.

When container 300 is loaded into module 200, SFN module 356 connects to microcontroller 363. If safety interlock switch 212 is opened by opening of module door 211, the display 120 can indicate that the module door 211 is open and the machine cycle may not start. Once the module door 211 is closed, the safety interlock switch 212 is closed and the microcontroller 363 reads the identification authentication of SFN module 356. The ultrasonic sensor 369 continuously reads the fluid level in the container 300 and transfers the data to the microcontroller 363. If authentication is found to be valid, the machine cycle can start.

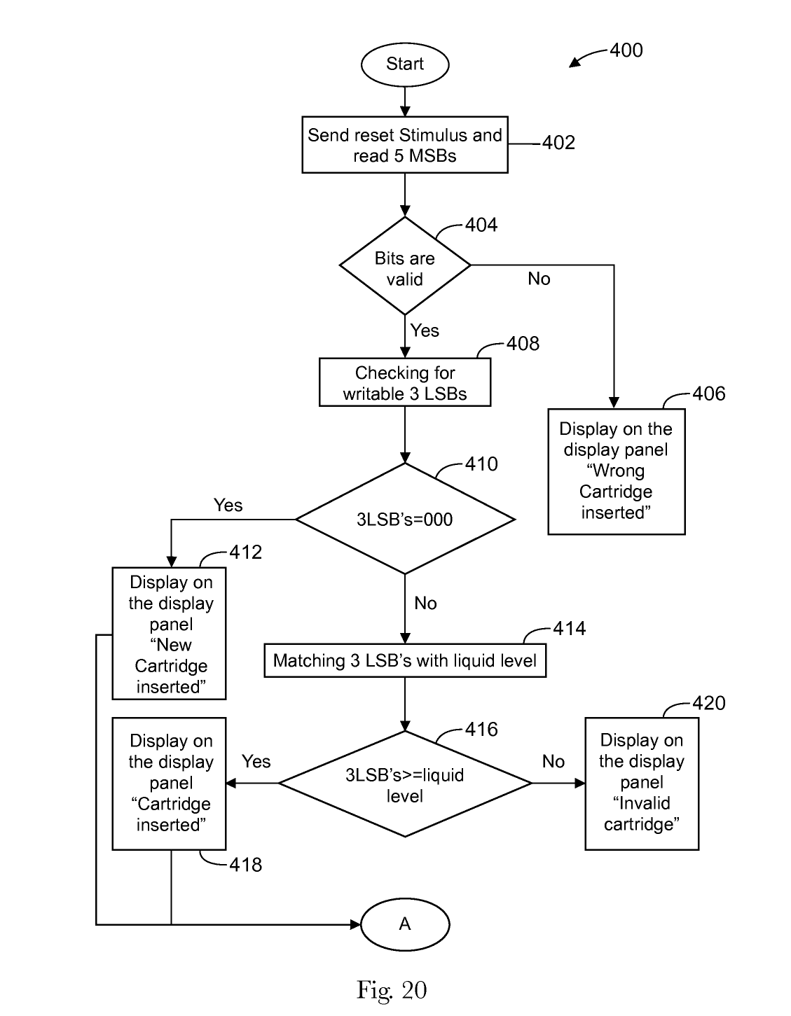

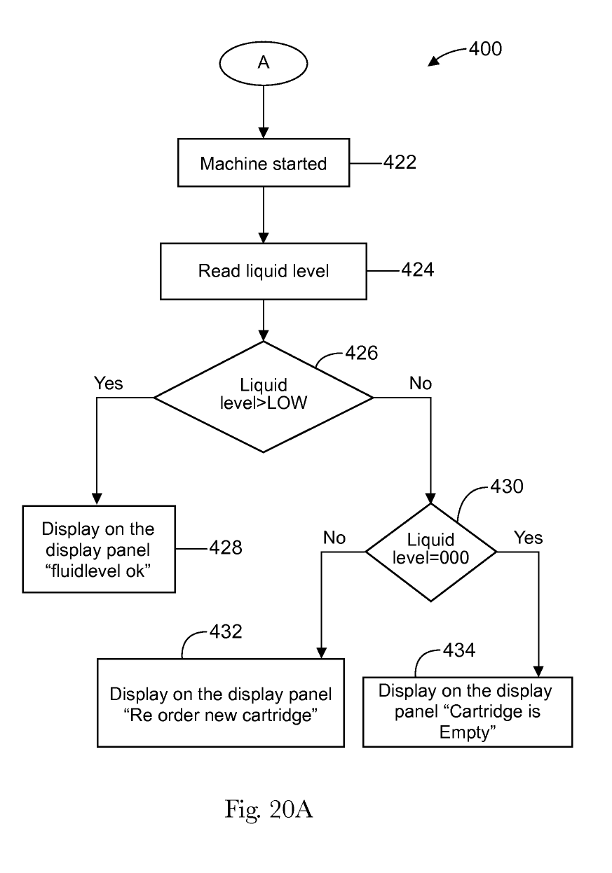

Shown in FIGS. 20 and 20A is one embodiment of an authentication and level detection process 400, which may be used by the microcontroller 363 to authenticate and sense the fluid level in container 300. The process 400 uses the combination of signals received from SFN module 356 and fluid level sensor 363 to determine if the container 300 inserted in the machine 100 is authentic and interacts with the user through the display 120. When the container 300 is inserted in the module 200, the machine 100 microcontroller 363 senses the presence of the container 300, sends 402 a request for the data and reads the 5 most significant bits from the EEPROM of the SFN module 356 containing the product identification authentication information. The microcontroller 363 determines 404 if the 5 most significant bits are valid. If the bits are not valid, the process 400 continues along the “no” branch and displays 406 on the display 120 that a wrong container 300 has been inserted. If the bits are valid, the process 400 continues along the “yes” branch and the microcontroller 363 checks 408 for the writable 3 least significant bits on the SFN module 356. The fluid level data is written in the 3 least significant bits. In a new container 300, the 3 least significant bits are set to 000. The microcontroller 363 determines 410 if the 3 least significant bits on the SFN module 356 read 000, and if true, the process 400 continues along the “yes” branch and displays 412 on the display 120 that a new container 300 is inserted. If not, the process 400 continues along the “no” branch and the microcontroller 363 compares 414 the 3 least significant bits with the sensed fluid level. The microcontroller 363 determines 416 if the 3 least significant bits are greater than or equal to the sensed fluid level. If true, the process 400 continues along the “yes” branch and displays 418 on the display 120 that the container 300 is inserted. If the 3 least significant bits are less than the sensed fluid level, the process continues along the “no” branch and displays 420 on the display 120 shows that an invalid container has been inserted. If the container is found valid, then the machine cycle starts 422 and the ultrasonic fluid level sensor 369 continuously reads 424 the fluid level in the container 300 and provides the signal to the microcontroller 363. The microcontroller 363 then compares 426 the measured fluid level to the preset low fluid level. If the measured fluid level is greater than the preset low fluid level, the process 400 continues along the “yes” branch and displays 428 on the display 120 that the fluid level is adequate. If not, process 400 continues along the “no” branch and the microcontroller 363 compares 430 the measured fluid level to a zero fluid level. If the measured fluid level is greater than the set zero level, the process 400 continues along the “no” branch and displays 432 on the display 120 that the container 300 fluid level is low. If the fluid level measured is zero, process 400 continues along the “yes” branch and displays 434 on the display 120 that the container 300 is empty.

In various embodiments, a method of using a modular fluid dispensing system comprising a module configured to receive a first container containing a first fluid and a second container containing a second fluid, can comprise selecting a first fluid dose amount to be provided by the first container to a machine, inserting the first container into the module, selecting a second fluid dose amount to be provided by the second container to the machine, inserting the second container into the module, withdrawing the first fluid dose amount from the first container at a first instance during an operating cycle of the machine, and withdrawing the second fluid dose amount from the second container at a second instance during the operating cycle of the machine. In one embodiment, selecting the first fluid dose can comprise moving a cover on the first container to expose one of a first exposable portion and a second exposable portion to the modular fluid dispensing system. In other various embodiments, selecting the second fluid dose can comprise rotating a cover on the first container to expose one of a first exposable portion and a second exposable portion to the modular fluid dispensing system.

The dimensions and values disclosed herein are not to be understood as being limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All parts, ratios, and percentages herein, in the Specification, Examples, and Claims, are by weight and all numerical limits are used with the normal degree of accuracy afforded by the art, unless otherwise specified.

All documents cited in the Detailed Description of the Invention are incorporated herein by reference; the citation of any document is not to be construed as an admission that it is prior art with respect to the present dispensing system. To the extent that any meaning or definition of a term in this written document conflicts with any meaning or definition of the term in a document incorporated by reference, the meaning or definition assigned to the term in this written document shall govern.

While particular embodiments of the present dispensing system have been illustrated and described, it would be obvious to those skilled in the art that various other changes and modifications can be made without departing from the spirit and scope of the present dispensing system. It is therefore intended to cover in the appended claims all such changes and modifications that are within the scope of the present dispensing system.

What is claimed is:

1. A modular fluid dispensing system configured to dispense at least one fluid to a machine wherein the machine comprises an aperture therein, the modular fluid dispensing system comprising:
a module configured to be removably engaged with the aperture of the machine, wherein the module comprises:
at least one receiving chamber configured to receive at least one container, the at least one container configured to receive the at least one fluid;
at least one engagement key configured to be engaged with a receiver portion of the aperture; and
a fluid extracting element defining a passage therethrough, wherein the fluid extracting element is configured to engage a portion of the at least one container to withdraw a portion of the at least one fluid from the at least one container into the passage and to the machine.

2. The modular fluid dispensing system of claim 1 comprising a selectable fluid dosing system positioned on one of the at least one container and the module.

3. The modular fluid dispensing system of claim 2 wherein the selectable fluid dosing system comprises at least one exposable member, wherein the at least one exposable member is exposed to a portion of the modular fluid dispensing system to instruct the fluid extracting element to withdraw a first dose of the at least one fluid from the at least one container.

4. The modular fluid dispensing system of claim 1 comprising a fluid level detection system configured to detect the level of the at least one fluid within the at least one container.

5. The modular fluid dispensing system of claim 1 comprising a container authentication system configured to authenticate the at least one container.

6. The modular fluid dispensing system of claim 5 comprising a fluid level detection system configured to detect the level of the at least one fluid within the at least one container, wherein the fluid level detection system is configured to interact with the container authentication system to determine if the at least one container is authentic.

7. The modular fluid dispensing system of claim 5 wherein at least one container comprises a readable tag configured to be read by the container authentication system.

8. The modular fluid dispensing system of claim 1 wherein the at least one receiving chamber comprises:
a first receiving space;
a second receiving space; and
wherein the at least one container comprises:
a first container configured to receive a first fluid and be positioned within the first receiving space; and
a second container configured to receive a second fluid and be positioned within the second receiving space.

9. The modular fluid dispensing system of claim 8 wherein the first container comprises a first engagement key, wherein the second container comprises a second engagement key, and wherein the first engagement key is different than the second engagement key.

10. The modular fluid dispensing system of claim 1 comprising:
a longitudinally oriented slot on a side wall of the aperture; and
a longitudinally oriented projection on the module, wherein the longitudinally oriented projection is configured to be at least partially engaged with the longitudinally oriented slot when the module is positioned within the aperture.

11. A modular fluid dispensing system for a machine, comprising:
a removable module comprising a receiving chamber for receiving at least one container configured to contain a fluid, the removable module comprising:
a container authentication system configured to interact with an authentication portion of the at least one container; and
a fluid dosing system interface configured to interact with a selectable fluid dosing system located on the at least one container.

12. The modular fluid dispensing system of claim 11 comprising at least one tube configured to withdraw the fluid from the container.

13. The modular fluid dispensing system of claim 11 wherein the container authentication system is configured to authenticate the at least one container and activate at least one of the modular fluid dispensing system and the appliance.

14. The modular fluid dispensing system of claim 11 wherein the fluid dosing system interface is configured to instruct the modular fluid dispensing system to withdraw one of a first fluid dose and a second fluid dose from the at least one container based on a setting of the selectable fluid dosing system of the at least one container.

15. A container configured to be used with a fluid dispensing system for a machine wherein the container is configured to contain a fluid such that the fluid can be provided to the fluid dispensing system, the container comprising:
a selectable fluid dosing system comprising at least one user activation member, wherein the fluid dispensing system extracts a first dose amount of the fluid when the user activation member is in a first position, and wherein the fluid dispensing system extracts a second dose amount of the fluid when the user activation member is in a second position.

16. The container of claim 15 wherein the selectable fluid dosing system comprises:
a first exposable member, wherein when the first exposable member is exposed to an interface of the fluid dispensing system, the fluid dispensing system is configured to withdraw the first dose amount of the fluid from the container; and
a second exposable member, wherein when the second exposable member is exposed to the interface of the fluid dispensing system, the fluid dispensing system is configured to withdraw a second dose amount of the fluid from the container and wherein the first dose amount is different than the second dose amount.

17. The container of claim 15 comprising an authentication portion configured to interact with a container authentication system to authenticate the container.

18. The container of claim 15 wherein said selectable fluid dosing system comprises at least one exposable member which is at least partially obscured by a cover wherein said cover is a rotatable cover, a peelable cover, a slide, or a combination thereof.

19. An appliance, comprising:
a modular fluid dispensing system configured to dispense at least one fluid from at least one container to the appliance, the modular fluid dispensing system comprising:
a module comprising a receiving chamber configured to receive the at least one container;
a fluid extracting element configured to withdraw the at least one fluid from the at least one container;
a container authentication system configured to interact with an authentication portion of the at least one container; and
a fluid dosing system interface configured to interact with a selectable fluid dosing system of the at least one container.

20. A method of using a modular fluid dispensing system, wherein the modular fluid dispensing system comprises a module configured to receive a first container containing a first fluid and a second container containing a second fluid, the method comprising:
selecting a first fluid dose amount to be provided by the first container to a machine;
inserting the first container into the module;
selecting a second fluid dose amount to be provided by the second container to the machine;
inserting the second container into the module;
withdrawing the first fluid dose amount from the first container at a first instance during an operating cycle of the machine; and
withdrawing the second fluid dose amount from the second container at a second instance during the operating cycle of the machine.
